(19) United States
(12) Patent Application Publication
(10) Pub. No.: US 2023/0029052 A1
(43) Pub. Date: Jan. 26, 2023

(54) CONNECTING ROD FOR A TURBINE ENGINE NACELLE

(71) Applicant: SAFRAN NACELLES, Gonfreville-l'Orcher (FR)

(72) Inventors: Laurent Georges Valleroy, Moissy-Cramayel (FR); François Bellet, Moissy-Cramayel (FR)

(73) Assignee: SAFRAN NACELLES, Gonfreville-l'Orcher (FR)

(21) Appl. No.: 17/862,806

(22) Filed: Jul. 12, 2022

(30) Foreign Application Priority Data
Jul. 12, 2021 (FR) 2107575

(51) Int. Cl. F02K 1/76; F02K 1/78; F02K 1/12

(52) U.S. Cl. CPC F02K 1/763; F02K 1/78; F02K 1/12

(57) ABSTRACT

A connecting rod for a nacelle of a turbine engine is described. The connecting rod includes a region configured to move the center of aerodynamic forces able to be exerted on the connecting rod, in the direction of an air flow intended to be generated during a thrust generated by the turbine engine.

### TECHNICAL FIELD

Embodiments of the current disclosure relate to cascade thrust reversers and relates, more particularly, to the configuration of the connecting rods of such thrust reversers.

### BACKGROUND

An aircraft generally comprises a propulsion unit formed by a plurality of turbojet engines supplying the thrust necessary for its movement. Each turbojet engine is housed in a nacelle which also comprises a set of actuators for elements providing various functions when the turbojet is in operation or at rest.

Some nacelles comprise, for example, a mechanical thrust reverser system ending in a discharge nozzle, the outlet of which is located at the rear of the nacelle. The role of the thrust reverser during landing of an aircraft is to reduce the braking distance by redirecting forwardly at least a part of the thrust generated by the turbojet engine. The air flow thus redirected, generates a counter-thrust contributing to the braking of the aircraft.

In some arrangements, the thrust reverser obstructs the discharge nozzle by a solid obstacle in order to redirect the secondary air flow forwards.

Modern aircraft are generally equipped with cascade thrust reversers, comprising a plurality of blocking flaps mounted in an articulated manner on a movable cowl so as to uncover or conceal vane cascades. The vane cascades are capable of radially reorienting the secondary air flow when the aircraft is braking.

The movable cowl can be moved longitudinally in translation between a closed position, commonly referred to as “direct jet” in which the cascades are concealed inside the cowl, and an open or “reverse jet” position in which the cascades provide their deflection function.

The cascade thrust reverser comprises a plurality of connecting rods, the function of which is to connect the blocking flaps to an internal structure of the nacelle commonly called an IFS (for “Inner Fixed Structure”). In other words, when the thrust reverser operates in direct jet mode, the blocking flaps are held by the connecting rods so as to allow the circulation of the secondary air flow, whereas when it operates in reverse jet mode, the flaps are actuated and positioned by the connecting rods so as to deflect the secondary air flow.

However, it has been observed that the orientation of the air flow has a tendency to vary. By way of example, the configuration of the scoops disturbs the orientation of the air flow when it is used for ventilating the fan compartment. These disturbances are capable of stressing the connecting rod in such a way as to cause it to bend, twist or oscillate and can thus damage it, increasing drag and reducing the efficiency of the turbine engine.

It is therefore proposed to reinforce the strength of the connecting rod in order to cope with various mechanical stresses, by increasing its thickness. Nevertheless, such a sizing is not without consequences for the mass and drag, which then increase significantly.

Moreover, the thickness of the connecting rod is chosen empirically because it remains complex to determine with precision the nature of the air flows to which the connecting rod is exposed, as well as the level of vibrations that they generate.

The connecting rod thus remains subject to the same problem with additional disadvantages.

The challenge is therefore to dimension a connecting rod for a cascade thrust reversal flap so to withstand the various mechanical stresses while minimizing the impact on its mass and on the drag.

### SUMMARY

Examples of a connecting rod for a nacelle of an aircraft turbine engine are disclosed. In an embodiment, the connecting rod comprises a region configured to move the center of aerodynamic forces able to be exerted on the connecting rod, in the direction of an air flow intended to be generated during a thrust generated by the turbine engine.

Such a region makes it possible to misalign the center of aerodynamic forces from the axis of rotation of the connecting rod, thus significantly reducing the risk of deterioration of the connecting rod.

In some embodiments, the connecting rod comprises damping means capable of reducing the oscillations of the connecting rod when the thrust is generated by the turbine engine.

In some embodiments, the damping means comprise a U-shaped spring with tabs, capable of surrounding the ball joint of the foot of the connecting rod inside its bracket.

In some embodiments, the connecting rod comprises a leading edge facing the thrust, the region being in the form of a stabilizer integral with a surface of the connecting rod, the stabilizer extending in a direction opposite to the leading edge.

“Leading edge” shall be understood as the front surface in direct jet mode of an aerodynamic profile element, in this case the connecting rod, which faces an air flow. The air flow is therefore separated into two on contact with the front surface.

It is therefore the stabilizer which stabilizes the connecting rod when the air flow passes it, which is capable of generating a high-level of vibration.

Such a stabilizer is also capable of orienting the connecting rod along the streamlines of the air flow in order to reduce the drag.

To this effect, it is advantageous to position the stabilizer so that it is in contact with, or in proximity with, the air flow where the flow can be substantially laminar.

In an alternative, the region has a curved longitudinal cross-section.

By curving the connecting rod over a predetermined length, this has the same advantages as a stabilizer.

The center of aerodynamic forces is then exerted over the curved region of the connecting rod.

In some embodiments, the connecting rod comprises a leading edge at least partially in the form of a tie rod, the region being integral with a surface of the connecting rod which is opposite the leading edge.

The tie rod is arranged so as to create a direct transmission of the forces between the two ball joints of the connecting rod.

Consequently, the stiffness of the connecting rod is increased in tension and in compression.

In an alternative, the region comprises all of the connecting rod.

According to another aspect, a cascade thrust reverser of a nacelle is proposed. In an embodiment, the cascade thrust reverser comprises a connecting rod according to any of the embodiments set forth above. The connecting rod is intended to be fixed on an internal structure of the nacelle.

According to another aspect, a system for suspending a turbine engine on an aircraft mast is proposed. In an embodiment, the aircraft mast comprises at least two connecting rods according to any embodiments set forth above.

The disclosure also relates to a nacelle for an aircraft turbine engine comprising a cascade thrust reverser and/or a turbine engine suspension system according to any of the embodiments set forth above.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 schematically shows a turbine engine nacelle for an aircraft, comprising a cascade thrust reverser according to the prior art;

FIG. 2A and FIG. 2B each show a view along an axial section of a cascade thrust reverser in direct jet position and in reverse jet position respectively, according to the prior art;

FIGS. 3-5 schematically illustrate various embodiments of connecting rod of a cascade thrust reversal flap according to the disclosure;

FIG. 6A and FIG. 6B illustrate examples of damping means arranged inside the bracket of the foot of the connecting rod, according to the disclosure and,

FIG. 7 schematically illustrates the nacelle comprising a system for suspending a turbine engine from an aircraft mast according to an embodiment of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

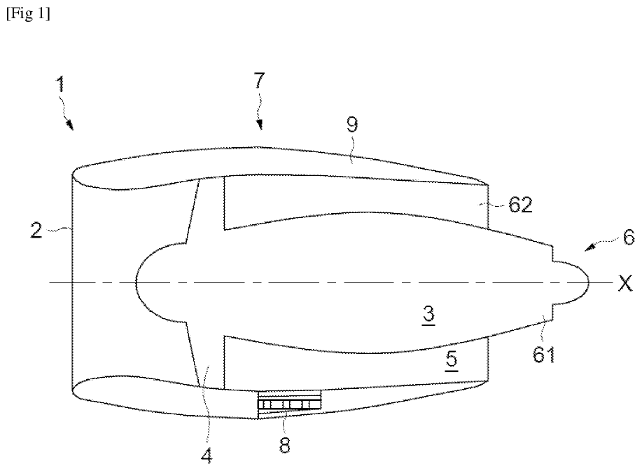

FIG. 1 shows a propulsion device 1 comprising a nacelle 2 of tubular structure along a longitudinal axis X. In the embodiment shown, the propulsion device 1 further comprises a turbine engine 3, for example of the turbofan-type, capable of generating, by blades of a rotating fan 4, a primary air flow and a secondary air flow.

The secondary air flow circulates outside the turbine engine 3 through an annular duct 5 formed between two walls of the nacelle 2. The primary and secondary flow are then discharged from the turbine engine 3 via a discharge nozzle 6 located at the rear of the nacelle 2. In some embodiments, the discharge nozzle 6 comprises a primary nozzle 61 capable of discharging the primary flow and a secondary nozzle 62 capable of discharging the secondary flow.

In order to reduce the braking distance of the aircraft during landing, the nacelle 2 comprises a mechanical cascade thrust reversal system 7. In some embodiments, the mechanical thrust reversal system 7 has the role of redirecting, towards the front of the nacelle 2, at least a part of the thrust generated by the turbine engine 3, thus creating a counter-thrust.

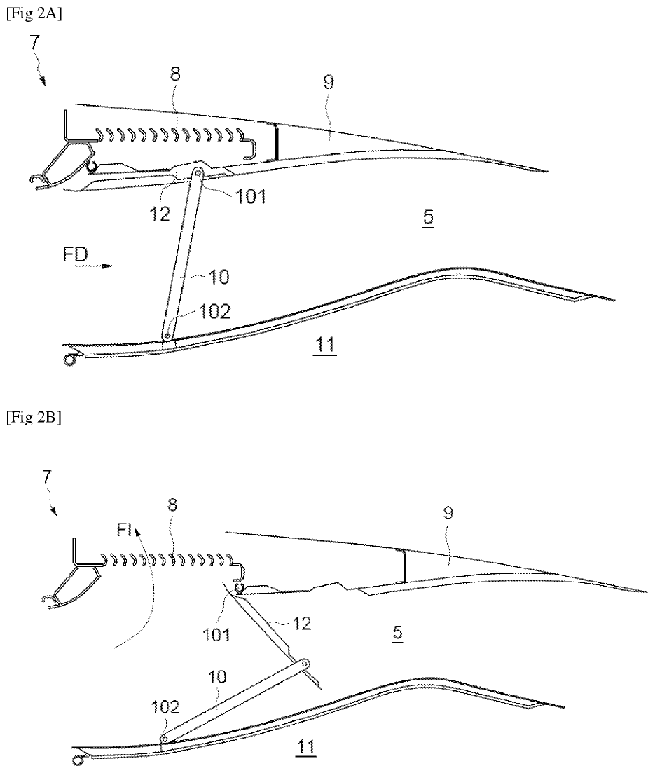

In order to do this, vane cascades 8 are concealed in a movable cowl 9 capable of sliding along rails from a closed position to an open position so as to uncover them and thus radially reorient the secondary airflow. The closed position is illustrated in FIG. 2A, which shows the movable cowl 9 comprising a plurality of blocking flaps 12.

A connecting rod 10, also referred to as connecting rod body, is pivotably mounted on the blocking flap 12 and on a fixed internal structure 11, commonly called IFS (for “Inner Fixed Structure”), capable of surrounding the rear portion of the turbine engine 3. The connecting rod 10 comprises a first articulation 101 on the blocking flap 12 and a second articulation 102 corresponding to foot of the connecting rod 10 which is arranged on the internal structure 11.

In other words, in a closed position, the secondary flow is able to circulate in the annular duct 5 and generate, with the first flow, a thrust FD.

In order to generate a counter-thrust as illustrated in FIG. 2B by reference sign FI, an actuator such as a hydraulic cylinder (not shown in the figure) slides the cowl 9 and causes the closing off of the annular duct 5 by the blocking flaps 12. Consequently, the secondary air flow is redirected through the vane cascades 8 in order to create the counter-thrust FI.

However, the thrust FD exposes the leading edge 13 of the connecting rod 10 to various forces, such as the drag force, the lift force and the drift force, constituting the aerodynamic forces. Moreover, the orientation of the air flow can vary, when the scoops use it to ventilate the fan compartment, for example. These disturbances and the forces exerted on the connecting rod are then likely to cause the connecting rod 10 to bend, twist and oscillate, or even damage it.

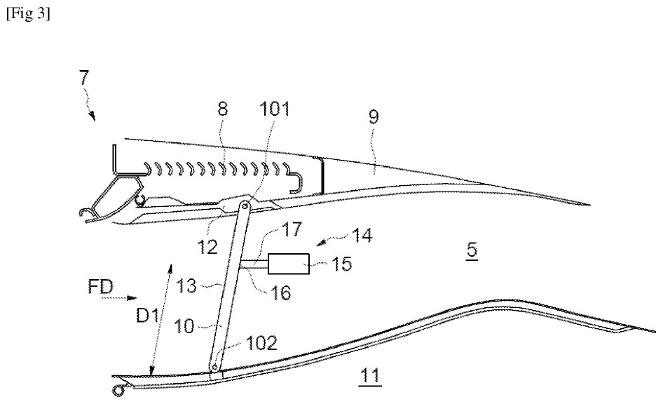

In order to protect the connecting rod 10 against such mechanical stresses, it comprises a region 14 as illustrated in FIG. 3. In some embodiments, the region 14 is configured to move the center of aerodynamic forces, able to be exerted on the connecting rod 10, in the direction of the thrust FD.

In this first embodiment, the region 14 is in the form of a stabilizer 15 integral with a surface 16 of the connecting rod 10 which is opposite the leading edge 13. By the stabilizer 15, the connecting rod 10 gains in stability when the air flow FD passes it and can be oriented as a function of the stream lines of the air flow.

Furthermore, it is advantageous to position the stabilizer 15 so that it is in contact with, or in proximity with, the air flow where the flow is laminar.

The stabilizer 15, the surface 16 and the rod 17 can be entirely machined in a same block of material as the connecting rod 10 in order to obtain a single part. Otherwise, the rod 17 is fixed to the surface 16, by any suitable fasteners, such as a screw connection for example.

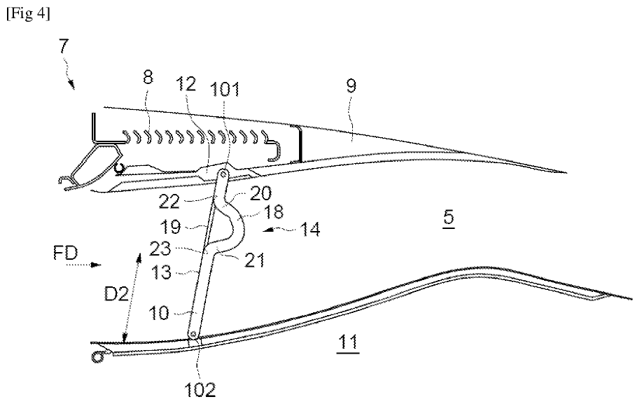

FIG. 4 illustrates a second embodiment of the region 14 of the connecting rod 10. In this example, the region 14 has a curved longitudinal section 18. In some embodiments, the connecting rod 10 has a convex curvature.

In order to facilitate the movement of the center of aerodynamic forces towards the region 14, the leading edge 13 of the connecting rod is partially in the form of a tie rod 19.

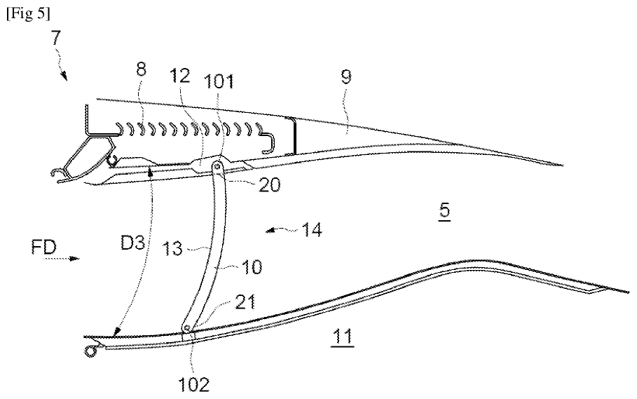

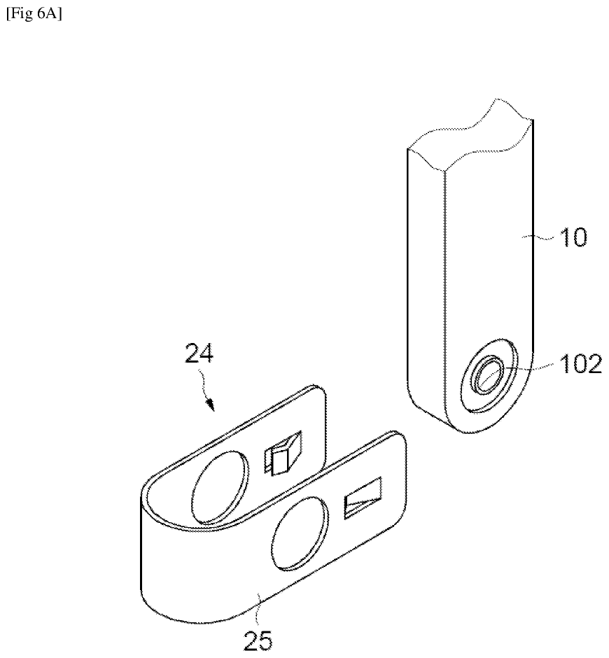

In some embodiments, the ends 20 and 21 of the curve are respectively integral with the ends 22 and 23 of the tie rod 19. In an alternative embodiment, and as illustrated in FIG. 5, the end 20 of the curve is connected to the first articulation 101 on the blocking flap 12 and the end 21 is connected to the second articulation 102 corresponding to the foot of the connecting rod 10.

In other words, the region 14 comprises the entire length D3 of the connecting rod 10.

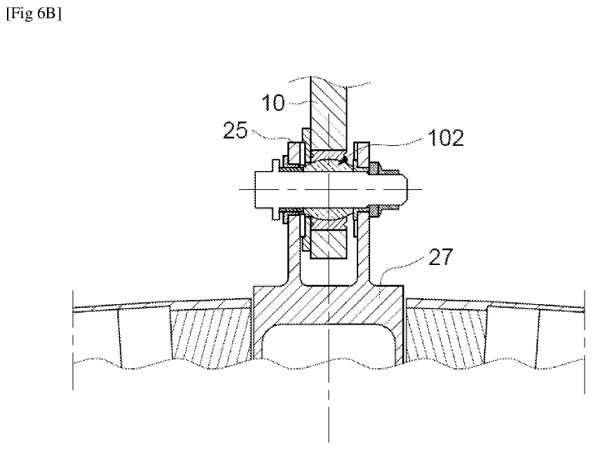

FIG. 6A illustrates damping means 24 capable of reducing any possible oscillations of the connecting rod 10 and hence of the stabilizer, when the thrust FD is generated by the turbine engine 3. In some embodiments, such damping means 24 comprise, for example, a U-shaped spring with tabs 25. The spring 25 is thus able to surround the second articulation 102 of the foot of the connecting rod 10, in this case a ball joint, inside its bracket 27 as illustrated in FIG. 6B.

Alternatively, the damping means 24 comprise elastomer washers arranged on each side of at least one articulation 101 or 102 of the connecting rod 10.

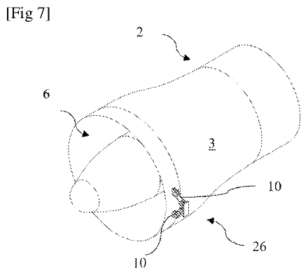

Reference is made to FIG. 7 which illustrates the nacelle 2 comprising a system 26 for suspending the turbine engine 3 from a mast of the aircraft, capable of being arranged on the rear portion of the turbine engine 3. In some embodiments, such a system comprises at least two connecting rods 10 configured to move the center of aerodynamic forces able to be exerted on each of them, in the direction of the air flow intended to be generated during the thrust PD. Each connecting rod 10 further comprises the damping means 24 and can have the stabilizer in the region 14. The region 14 can, in this case, have a curved longitudinal cross-section.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. Also, the term “about,” “approximately,” etc., means plus or minus 5% of the stated value.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A connecting rod for a nacelle of an aircraft turbine engine, comprising a region configured to move the center of the aerodynamic forces able to be exerted on the connecting rod in the direction of an air flow intended to be generated during a thrust generated by the turbine engine.

2. The connecting rod according to claim 1, further comprising damping means capable of reducing the oscillations of the connecting rod when the thrust is generated by the turbine engine.

3. The connecting rod according to claim 2, wherein the damping means comprise a U-shaped spring with tabs capable of surrounding the ball joint of the foot of the connecting rod inside its bracket.

4. The connecting rod according to claim 1, further comprising a leading edge facing the thrust, wherein said region is in the form of a stabilizer integral with a surface of the connecting rod, the stabilizer extending in a direction opposite to said leading edge.

5. The connecting rod according to claim 1, wherein the region has a curved longitudinal cross-section.

6. The connecting rod according to claim 5, further comprising a leading edge at least partially in the form of a tie rod, said region being integral with a surface of the connecting rod opposite said leading edge.

7. The connecting rod according to claim 5, wherein said region comprises all of the connecting rod.

8. A cascade thrust reverser of a nacelle, comprising a connecting rod according to claim 1, the connecting rod being intended to be fixed on an internal structure of the nacelle.

9. A system for suspending a turbine engine from an aircraft mast, comprising at least two connecting rods according to claim 1.

10. A nacelle for an aircraft turbine engine, comprising:
a cascade thrust reverser including a connecting rod with a region configured to move the center of the aerodynamic forces able to be exerted on the connecting rod in the direction of an air flow intended to be generated during a thrust generated by the turbine engine.

11. The nacelle according to claim 10, further comprising damping means capable of reducing the oscillations of the connecting rod when the thrust is generated by the turbine engine.

12. A nacelle for an aircraft turbine engine, comprising:
a suspension system for the turbine engine, the suspension system including a connecting rod with a region configured to move the center of the aerodynamic forces able to be exerted on the connecting rod in the direction of an air flow intended to be generated during a thrust generated by the turbine engine.

13. The nacelle according to claim 12, further comprising damping means capable of reducing the oscillations of the connecting rod when the thrust is generated by the turbine engine.
